(19) United States
(12) Patent Application Publication
(10) Pub. No.: US 2013/0285420 A1
(43) Pub. Date: Oct. 31, 2013

(54) INFLATABLE INFANT SEAT

(71) Applicant: Hana Bar BUZAGLO, Rishon Le Zion (IL)

(72) Inventor: Hana Bar BUZAGLO, Rishon Le Zion (IL)

(21) Appl. No.: 13/543,837

(22) Filed: Jul. 8, 2012

(30) Foreign Application Priority Data
Apr. 30, 2012 (IL) IL 219498

(51) Int. Cl. B60N 2/32

(52) U.S. Cl. 297/118

(57) ABSTRACT

An inflatable infant seat having inflatable cells, for changing a mode of the seat, where the mode is changeable to at least two of a small infant vehicular seat, a larger infant vehicular seat, and a stroller.

### CROSS-REFERENCE TO RELATED APPLICATIONS

Applicant hereby claims priority benefit of Israel Patent Application No. 219498, filed on Apr. 30, 2012, the disclosure of which is incorporated herein by reference in its entirety.

### FIELD OF THE INVENTION

The present invention relates to the field of infant seats. More particularly, the invention relates to an inflatable infant seat.

### BACKGROUND OF THE INVENTION

Infant seats for vehicles occupy significant space within the vehicle, which is not utilized while an infant is not present. U.S. Pat. No. 4,711,490 discloses an inflatable infant vehicular seat. The seat may be inflated for use, or deflated while the infant is not present.

However, like conventional infant vehicular seats, the inflatable infant vehicular seat of U.S. Pat. No. 4,711,490 provides a single mode of use only, even though the infant grows.

All the methods described above have not yet provided satisfactory solutions to the long felt need of fitting the infant vehicular seat to the current size of the infant.

It is an object of the present invention to provide a method and apparatus for fitting the infant vehicular seat to the current size of the infant.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to an inflatable infant seat (10) comprising a plurality of inflatable cells (14, 16, 18, 22), for changing a mode of the seat (10), wherein the mode is changeable to at least two members selected from a group including: a small-infant vehicular seat (62), a grown-up infant vehicular seat (64), a stroller (60).

The plurality of inflatable cells (14, 16, 18, 22) may comprise serially disposed vertically inflatable cells (14, 16, 18) forming a sitting space (50) between two thereof.

The plurality of inflatable cells (14, 16, 18, 22) may further comprise a rising inflatable cell (22) disposed below the serially disposed cells (14, 16, 18), for raising the serially disposed cells (14, 16, 18), for forming the stroller (60).

The inflatable infant seat (10) may further comprise foldable wheels (26) pivotally connected to the rising inflatable cell (22).

The inflatable infant seat (10) may further comprise an air pump (20), for allowing a user to fit the size of the sitting space (50) to the current size of an infant (44) while seated.

The inflatable infant seat (10) may further comprise an air pump (20), for allowing a user to perform changing the mode of the seat (10).

The air pump (20) may be capable of deflating and inflating the plurality of inflatable cells (14, 16, 18, 22).

The inflatable infant seat (10) may further comprise a relatively rigid plate (28), for supporting the sitting space (50).

The inflatable infant seat (10) may further comprise a slit (38) for inserting a seat belt (46) thereinto, thereby providing fastening the inflatable seat (10) to a vehicular seat (12).

The inflatable infant seat (10) may further comprise a selector (36), for selecting which of the inflatable cells (14, 16, 18, 22) is to be inflated.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 depicts an inflatable infant seat, according to one embodiment of the present invention.

FIG. 2 depicts the folding and the deploying of the wheels of FIG. 1.

FIG. 3 depicts the inflatable infant seat of FIG. 1 in a stroller mode thereof.

FIG. 4 depicts the infant seat of FIG. 1 connected to a vehicular seat.

FIG. 5 is a rear view of the inflatable infant seat of FIG. 1.

FIGS. 6 and 7 depict the difference between inflating two or three cells of the infant seat of FIG. 1.

It should be understood that the drawings are not necessarily drawn to scale.

### DETAILED DESCRIPTION OF THE INVENTION

The present invention will be understood from the following detailed description of the invention, which is meant to be descriptive and not limiting. For the sake of brevity, some well-known features, methods, systems, procedures, components, circuits, and so on, are not described in detail.

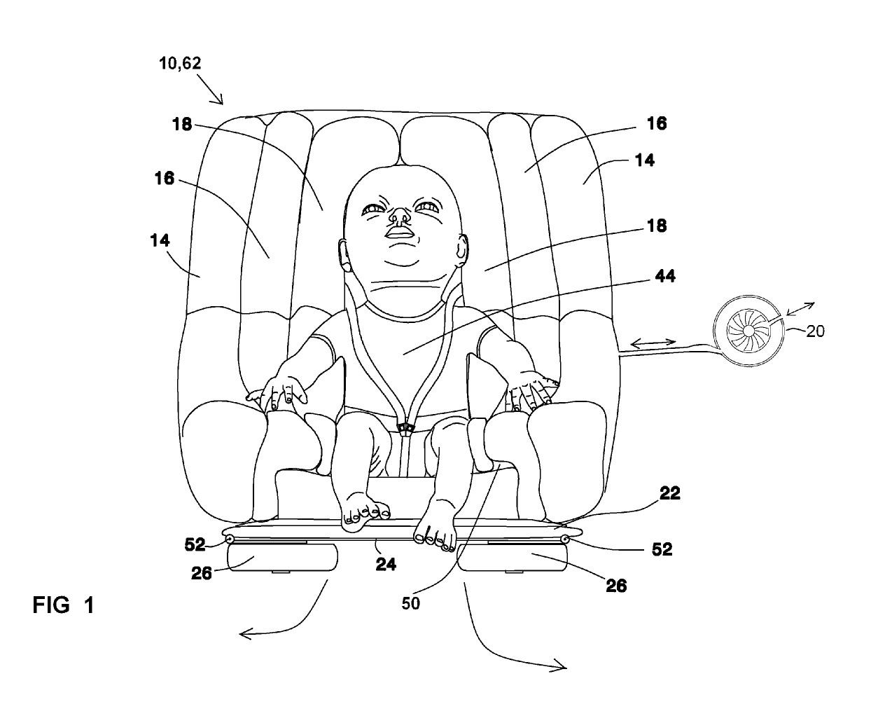

FIG. 1 depicts an inflatable infant seat, according to one embodiment of the present invention.

An inflatable infant seat 10 includes a plurality of inflatable cells, such as inflatable cells 14, 16, 18 and 22. This plurality provides adapting seat 10 several modes of change as a function of the inflated and deflated cells.

According to one embodiment shown in the example of FIG. 1, the plurality of inflatable cells 14, 16, and 18 are disposed serially and are vertically inflatable, forming a sitting space 50 between the cells enumerated 18.

Preferably, two cells enumerated 18 have an air opening therebetween, thus constituting a single inflatable cell; as well, preferably two cells enumerated 16 constitute a single inflatable cell; additionally, preferably two cells enumerated 14 constitute a single inflatable cell.

An air pump 20 may be operable either to inflate or to deflate a selected cell. According to the example of three cells, one of three sizes may be selected, thus allowing fitting the size of sitting space 50 to the current size of infant 44, being a function of the age thereof.

According to another embodiment, the last stage of the inflation may be performed after placing infant 44, while seated, for pressing the body and the head of infant 44 by the inflated cells, as shown in the figure.

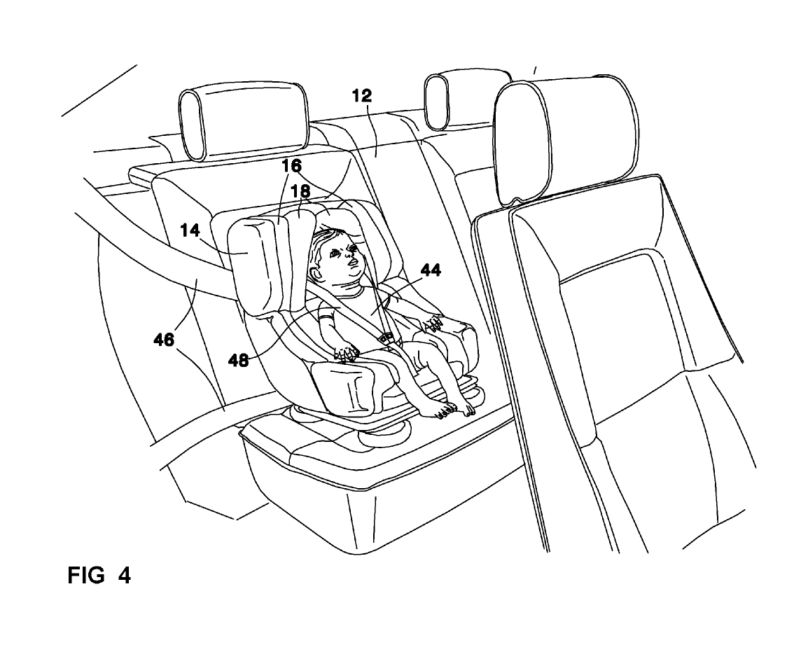

According to another embodiment shown in the example of FIG. 1, the plurality of inflatable cells 14, 16, and 18 may provide changing the mode of seat 10 from an infant vehicular seat 62 shown in FIG. 1 to a stroller 60 having wheels 26, shown in FIG. 3.

At the state of FIG. 1, being an infant vehicular seat, cell 22, disposed below cells 14, 16 and 18, is not inflated, and each of wheels 26 is folded horizontally about a hinge 52 below non-inflated cell 22.

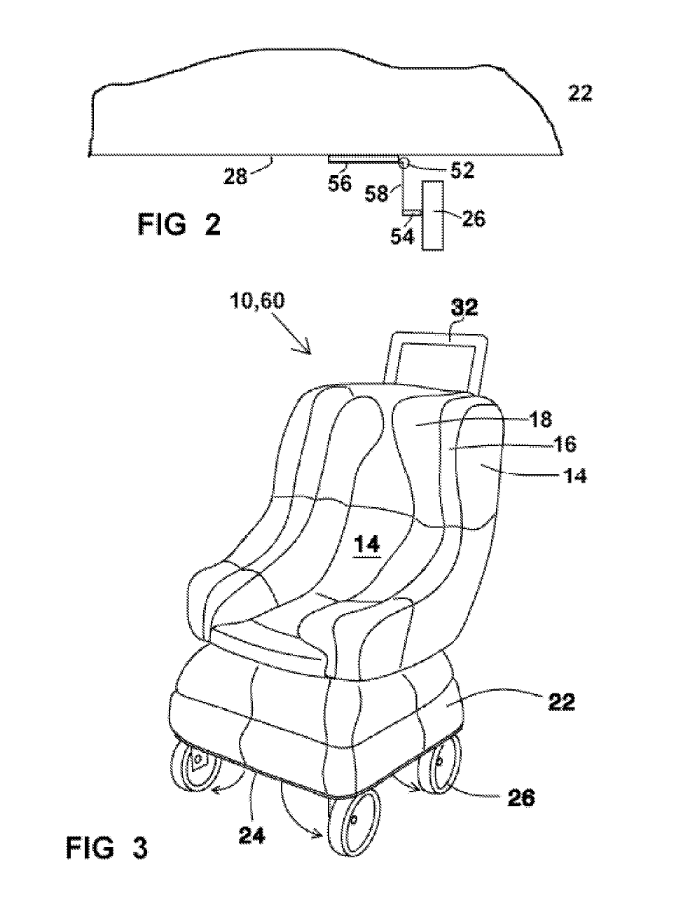

FIG. 2 depicts the folding and the deploying of the wheels of FIG. 1.

At the state of FIG. 2, cell 22, being disposed horizontally at the bottom, is inflated, and each of wheels 26 is deployed vertically about hinge 52 below inflatable cell 22. Wheels 26 are pivotally connected to inflatable cell 22.

Hinge 52 includes two hinged arms, namely an arm 56 fixed to a relatively rigid plate 28 of inflatable cell 22, and an arm 58 for carrying an axle 54 of wheel 26.

Rigid plate 28 provides a horizontal support to the sitting space 50.

FIG. 3 depicts the inflatable infant seat of FIG. 1 in a stroller mode thereof.

At the state of FIG. 3, being an infant vehicular stroller 60, cell 22 is inflated, thus raising cells 14, 16 and 18 to a significant height, and each of wheels 26 is deployed vertically about hinge 52 below non-inflated cell 22.

Inflatable seat 10 may be partially inflated for constituting an infant vehicular seat 62, or further inflated for constituting a stroller 60.

Changing the mode of the same device 10, from an infant vehicular seat 62 to a stroller 60, and vice versa, saves the parent the nuisance of transferring infant 44 from one device to another. Instead, the mode of the same device is changed, while infant 44 remains in the same position.

A handle 32 may preferably be included for carrying infant seat 10, hanged on handle 32 upon being a vehicular infant seat, or for transporting infant seat 10 on wheels 26 upon being formed to stroller 60.

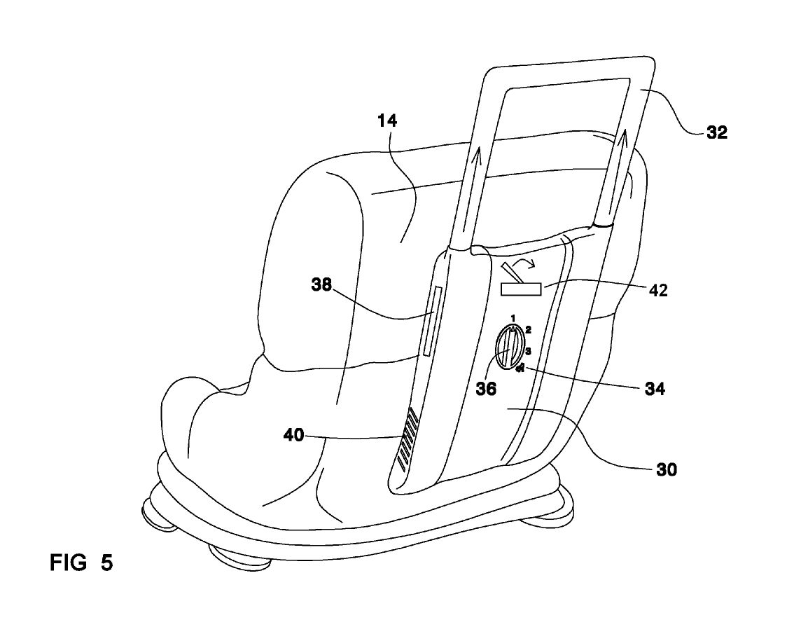

FIG. 4 depicts the infant seat of FIG. 1 connected to a vehicular seat.

Infant seat 10 is shown fastened to the vehicular seat 12 by a vehicular safety seat belt 46 of vehicular seat 12. Infant 44 is shown fastened to infant seat 10 by belts 48 of infant seat 10.

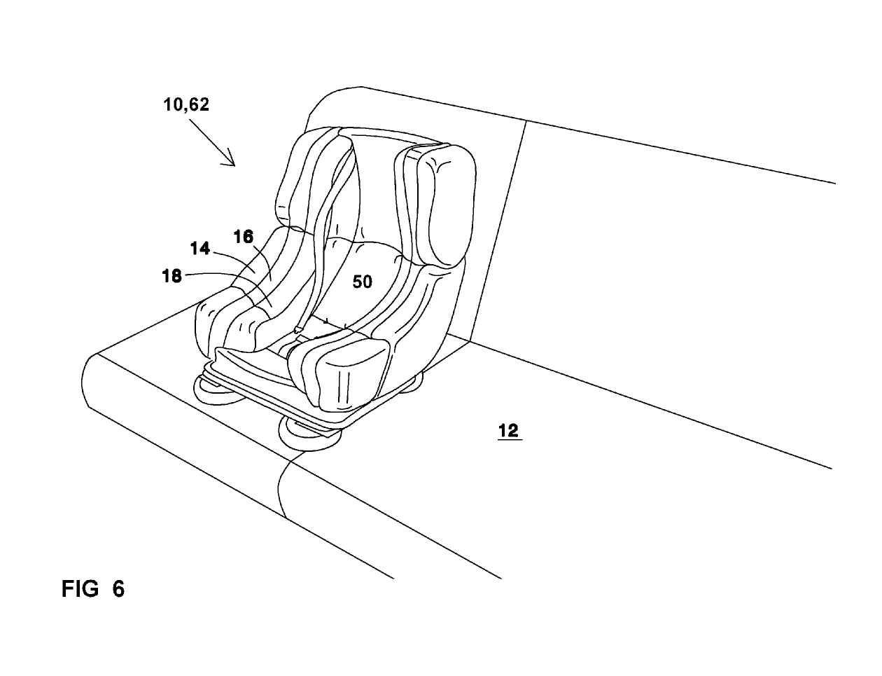

FIG. 5 is a rear view of the inflatable infant seat of FIG. 1.

Belts 48 of infant seat 10 are preferably connected by a packaging 30. A belt slit 38 within packaging 30 allows inserting safety seat belt 46, for fastening infant seat 10 to vehicular seat 12.

Air inlet 40 provides air entry and exit air pump 20 (not shown), for inflating cells 14, 16 and 18. A manual selector 36 or an automatic selector (not shown) may direct the incoming air to the selected cell, being either 14 or 16 or 18. A toggle switch, which may be manual or automatic, may select between inflating or deflating the selected cell. The selection of inflating or deflating requires changing the direction of the rotation of the blades (not shown) of pump 20, such as by changing the DC (direct current) voltage polarization supply.

For example, the parent may remove seat 10 from the vehicle while the infant sits, then select cell 22 by selector 36 for inflating by toggle switch 42, for turning seat 10 into stroller 60 (not shown). After transporting the infant on stroller 60, the parent may return to the vehicle and change the mode of toggle switch 42 to deflating for deflating cell 22, forming it back into infant vehicular seat 62.

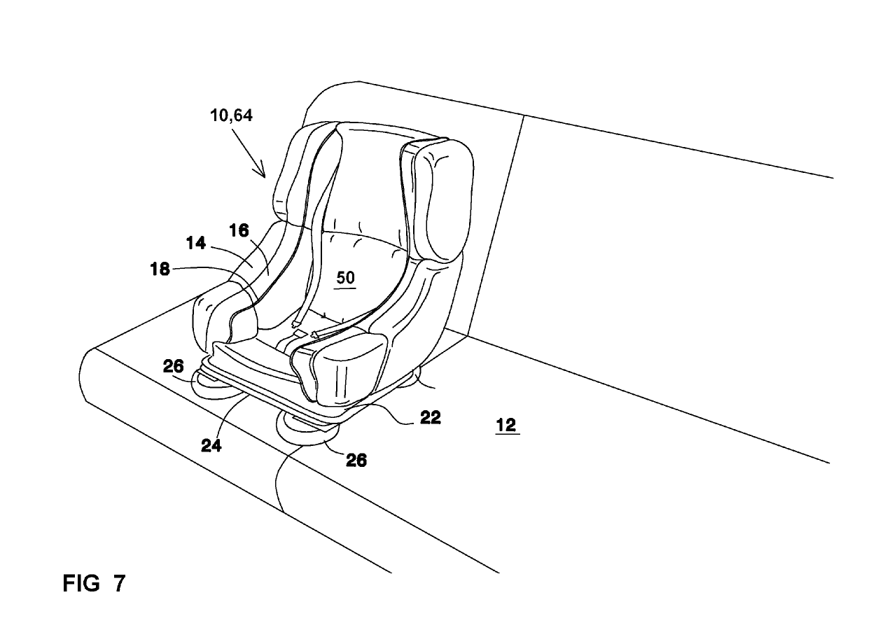

FIGS. 6 and 7 depict the difference between inflating two or three cells of the infant seat of FIG. 1.

FIG. 7 shows all cells 14, 16, and 18 inflated, thus providing a relatively small seating space 50, thus fitting a small infant 44, thus forming a small-infant vehicular seat 62. Upon growth of infant 44, at FIG. 7 only cells 14 and 16 are inflated, whereas cell 18 is not inflated, for enlarging seating space 50, thus forming a growing infant vehicular seat 64.

In the figures and/or description herein, the following reference numerals have been mentioned:
numeral 10 denotes an inflatable infant seat, according to one embodiment of the present invention; the inflatable seat may be partially inflated for constituting an infant vehicular seat, or further inflated for constituting a stroller;
numeral 12 denotes a vehicular seat;
numerals 14, 16 and 18 denote inflatable cells, said cells forming vertically erected walls upon being inflated;
numeral 20 denotes an air pump for inflating the inflatable cells;
numeral 22 denotes an inflatable cell which is disposed below the vertically erected inflatable cells, for raising those cells; thus it is named “raising inflatable cell”;
numeral 26 denotes a wheel of the stroller;
numeral 28 denotes a relatively rigid plate disposed at the bottom;
numeral 30 denotes a packaging;
numeral 32 denotes a handle;
numeral 36 denotes a selector, for selecting which cell will be inflated by an air pump;
numeral 38 denotes a slit for inserting a vehicular seat belt;
numeral 40 denotes an air inlet;
numeral 42 denotes a toggle switch, for selecting inflating or deflating;
numeral 44 denotes an infant;
numeral 46 denotes a vehicular safety seat belt;
numeral 48 denotes a belt of the infant seat of the present invention;
numeral 50 denotes a space for placing the infant to sit;
numeral 52 denotes a hinge, for folding the wheel;
numeral 54 denotes an axle of the wheel;
numerals 56 and 58 denote arms of the wheel;
numeral 60 denotes a stroller formed from the infant seat of the present invention;
numeral 62 denotes an infant vehicular seat, especially for a small infant, formed from the infant seat of the present invention; and
numeral 64 denotes an infant vehicular seat for a relatively larger infant, formed from the infant seat of the present invention.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An inflatable infant seat comprising a plurality of inflatable cells, for changing a mode of said seat, wherein said mode is changeable to at least two members selected from a group including: a small infant vehicular seat, a larger infant vehicular seat, and a stroller.

2. An inflatable infant seat according to claim 1, wherein said plurality of inflatable cells comprises serially disposed vertically inflatable cells forming a sitting space between two thereof.

3. An inflatable infant seat according to claim 2, wherein said plurality of inflatable cells further comprises a raising inflatable cell disposed below said serially disposed cells, for raising said serially disposed cells, for forming said stroller.

4. An inflatable infant seat according to claim 3, further comprising foldable wheels pivotally connected to said raising inflatable cell.

5. An inflatable infant seat according to claim 2, further comprising an air pump, for allowing a user to fit the size of said sitting space to the current size of an infant while seated.

6. An inflatable infant seat according to claim 1, further comprising an air pump, for allowing a user to perform said changing of the mode of said seat.

7. An inflatable infant seat according to claim 6, wherein said air pump is capable of deflating and of inflating said plurality of inflatable cells.

8. An inflatable infant seat according to claim 2, further comprising a relatively rigid plate, for supporting said sitting space.

9. An inflatable infant seat according to claim 1, further comprising a slit for inserting a safety seat belt thereinto, thereby providing fastening said inflatable seat to a vehicular seat.

10. An inflatable infant seat according to claim 1, further comprising a selector, for selecting which of said inflatable cells is to be inflated.
